(19) United States
(12) Patent Application Publication
(10) Pub. No.: US 2018/0068511 A1
(43) Pub. Date: Mar. 8, 2018

(54) FINGERPRINT LOCK SYSTEM AND KEY DEVICE THEREOF

(71) Applicant: STARTEK ENGINEERING INCORPORATED, Hsinchu (TW)

(72) Inventor: Wen-Hsing HSU, Hsinchu (TW)

(73) Assignee: STARTEK ENGINEERING INCORPORATED, Hsinchu (TW)

(21) Appl. No.: 15/696,979

(22) Filed: Sep. 6, 2017

(30) Foreign Application Priority Data
Sep. 7, 2016 (CN) 201610806895.7

(51) Int. Cl. G07C 9/00; G08B 13/08; G08B 25/10

(52) U.S. Cl. CPC G07C 9/00563; G07C 9/00158; G07C 9/00309; G08B 25/10; G08B 13/08

(57) ABSTRACT

A fingerprint lock system includes a key device and a lock device. The key device includes a communication and power transmitting module, a fingerprint sensing module, and a battery. The fingerprint sensing module senses a fingerprint input and accordingly generates fingerprint data. The communication and power transmitting module outputs the fingerprint data and a supplying power. The lock device includes a communication and power receiving module, a storage module, and a processing module. The communication and power receiving module receives the fingerprint data and the supplying power from the key device to supply the storage module and the processing module with the supplying power. The storage module stores verification data. Each verification data includes minutiae features corresponding to a fingerprint. The processing module verifies if the fingerprint data has the minutiae features corresponding to the fingerprint and, if so, performs an unlock operation.

### CROSS-REFERENCE TO RELATED APPLICATION

This non-provisional application claims priority under 35 U.S.C. § 119(a) to Patent Application No. 201610806895.7 filed in China, P.R.C. on Sep. 7, 2016, the entire contents of which are hereby incorporated by reference.

### BACKGROUND

### Technical Field

The instant disclosure relates to a lock system and, more particularly, to a fingerprint lock system and a key device thereof.

### Related Art

Fingerprint recognition technologies are broadly applied to various fields nowadays. For example, fingerprint recognition technologies can be applied to access a control field. A fingerprint device can be installed adjacent to a door to control the access of personnel. A fingerprint sensor of the fingerprint device is required to be exposed to allow the personnel who need to access the door to operate the fingerprint sensor. However, the risk of the fingerprint sensor being sabotaged is increased.

### SUMMARY

To address the above issue, an embodiment of the instant disclosure provides a fingerprint lock system comprising a key device and a lock device. The key device comprises a communication and power transmitting module, a fingerprint sensing module, and a battery. The battery provides an operating power to supply operation of the communication and power transmitting module and the fingerprint sensing module. The fingerprint sensing module senses a fingerprint input and accordingly generates fingerprint data. The communication and power transmitting module outputs the fingerprint data and a supplying power. The lock device comprises a communication and power receiving module, a storage module, and a processing module. The communication and power receiving module receives the fingerprint data and the supplying power from the key device to supply the storage module and the processing module with the supplying power. The storage module stores at least one verification data. Each of the verification data comprises a plurality of minutiae features corresponding to a fingerprint. The processing module verifies if the fingerprint data has the minutiae features corresponding to the fingerprint and, if so, performs an unlock operation.

An embodiment of the instant disclosure provides a key device comprising a communication and power transmitting module, a fingerprint sensing module, and a battery. The battery provides an operating power to supply operation of the communication and power transmitting module and the fingerprint sensing module. The fingerprint sensing module senses a fingerprint input and accordingly generates fingerprint data. The communication and power transmitting module outputs the fingerprint data and a supplying power generated based upon the operating power.

Concisely, according to the embodiments of the instant disclosure, the fingerprint lock system has less risk of the lock device being sabotaged since the lock device and the key device are separated. A user can use the same key device to unlock multiple lock devices and consequently has no need to carry multiple keys, which is more convenient. Additionally, the lock device can operate based upon the supplying power provided by the key device and has no need to depend on additional power supply. As a result, the lock device consumes less power and avoids an issue that the lock device may be unable to be unlocked in the case of the lock device running out of power or the additional power supply being interrupted.

### BRIEF DESCRIPTION OF THE DRAWINGS

FIG. 1 illustrates a perspective view of a fingerprint lock system according to an embodiment of the instant disclosure;

FIG. 2 illustrates a perspective view of a key device according to an embodiment of the instant disclosure;

FIG. 3 illustrates a block diagram of a fingerprint lock system according to an embodiment of the instant disclosure; and

FIG. 4 illustrates a perspective view of a key device according to another embodiment of the instant disclosure.

### DETAILED DESCRIPTION

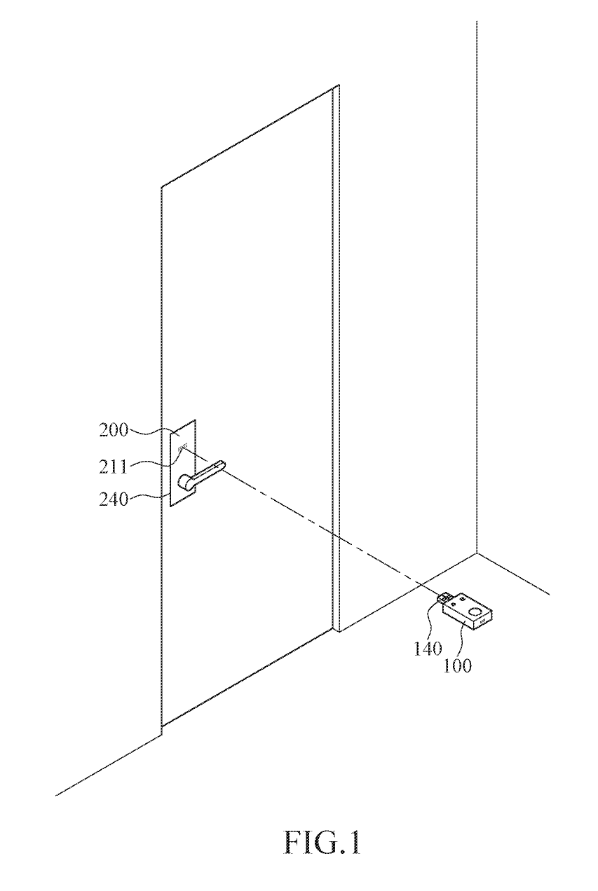

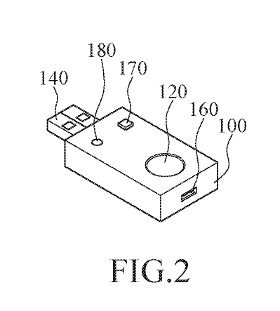

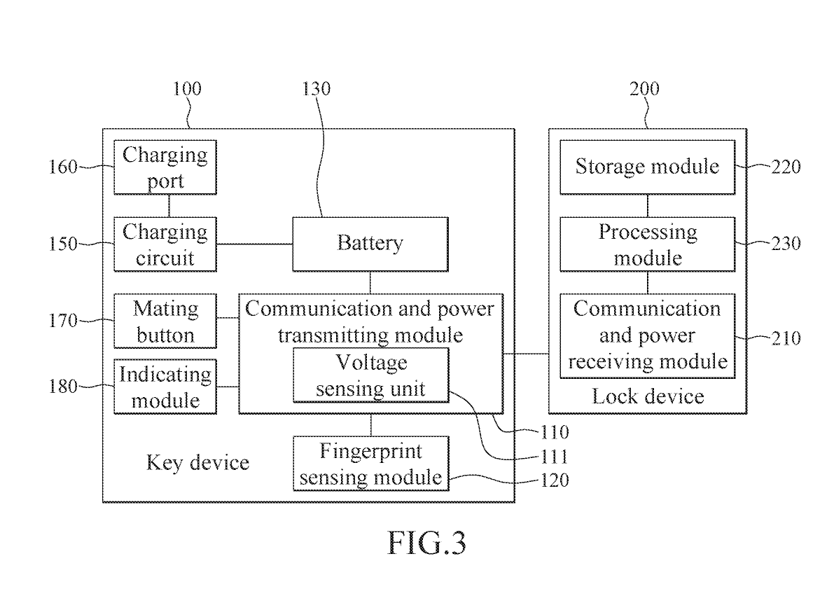

FIG. 1 is a perspective view of a fingerprint lock system according to an embodiment of the instant disclosure. The fingerprint lock system comprises a key device 100 and a lock device 200. In the embodiment, for example, the lock device 200 is, but is not limited to, a door lock installed on a door. In some embodiments, the lock device 200 can be a motorcycle lock installed on a motorcycle, a luggage lock, a coffer lock, etc. FIG. 2 is a perspective view of the key device 100 according to an embodiment of the instant disclosure. FIG. 3 is a block diagram of the fingerprint lock system according to an embodiment of the instant disclosure.

Please refer to FIG. 1 to FIG. 3. The key device 100 comprises a communication and power transmitting module 110, a fingerprint sensing module 120, and a battery 130. The battery 130 is an expendable battery for providing an operating power to supply electricity for the operation of the communication and power transmitting module 110, the fingerprint sensing module 120, and other components in the key device 100. The fingerprint sensing module 120 is for sensing a fingerprint input and accordingly generating fingerprint data in an optical manner, in a capacity manner, or by any suitable fingerprint sensors. In other words, when a user presses the fingerprint sensing module 120 of a pressing type (or slides on the fingerprint sensing module 120 of a sliding type) with a fingertip, the fingerprint sensing module 120 can obtain a fingerprint pattern and accordingly analyze the fingerprint pattern to obtain a plurality of minutiae features corresponding to the fingerprint pattern so as to form fingerprint data. The communication and power transmitting module 110 can output the fingerprint data and a supplying power generated based upon the operating power. Thus, the lock device 200 has no need to depend on additional power supply. As a result, the lock device 200 consumes less power and avoids an issue that the lock device 200 may be unable to be unlocked in the case of the lock device 200 running out of power or the additional power supply being interrupted.

The lock device 200 comprises a communication and power receiving module 210, a storage module 220, and a processing module 230. The communication and power receiving module 210 receives the fingerprint data and the supplying power from the key device 100 to supply the storage module 220 and the processing module 230 with the supplying power. The storage module 220 stores at least one verification data. Each of the verification data comprises the minutiae features corresponding to a fingerprint. The storage module 220 can be a flash memory, an electrically-erasable programmable read-only memory (EEPROM), or other storage media. The processing module 230 can be a processor such as a micro controller or an embedded controller and is connected to the storage module 220 for verifying if the fingerprint data has the minutiae features corresponding to the fingerprint and, if so, performing an unlock operation. In other words, the processing module 230 can verify if the fingerprint data obtained by the key device 100 matches the at least one verification data. Under the circumstances that the fingerprint data matches the verification data, the user with the key device 100 is authorized to perform the unlock operation. As a result, the user can use the same key device 100 to unlock multiple lock devices 200 and has no need to carry multiple keys, which is more convenient. In the embodiment, the unlock operation generally means unlocking a lock. Nevertheless, in some embodiments the lock device 200 can be a computer or other electronic devices, and the unlock operation can be an alternative of an authority verification of software. In such cases, the unlock operation means removing restriction of permission.

As shown in FIG. 1, the lock device 200 comprises a housing 240. The communication and power receiving module 210 comprises a connecting receptacle 211. The connecting receptacle 211 is exposed from a surface of the housing 240. The storage module 220 and the processing module 230 are received in the housing 240 (not shown). The communication and power transmitting module 110 of the key device 100 comprises a connecting plug 140 for being connected to the connecting receptacle 211 so as to transmit the fingerprint data and the supplying power. Compared to a prior fingerprint device of which a fingerprint sensor is exposed, the fingerprint sensing module 120 and the lock device 200 are separated, and only the connecting receptacle 211 is exposed; therefore, the lock device 200 has less risk of being sabotaged. In the embodiment, the connecting plug 140 and the connecting receptacle 211 support the universal serial bus (USB) or other transmission protocols.

As shown in FIG. 3, the communication and power transmitting module 110 further comprises a voltage sensing unit 111 for sensing a voltage signal of the lock device 200 via the connecting plug 140 when the connecting plug 140 and the connecting receptacle 211 are connected to each other and outputting the supplying power to the lock device 200 when the voltage signal is less than a threshold. Whether there is an additional power supply for the lock device 200 can be confirmed according to the voltage signal. If the sensed voltage signal is greater than the threshold, there is an additional power supply for the lock device 200, and the key device 100 has no need to supply the lock device 200 with electricity. On the other hand, if the sensed voltage signal from the lock device 200 is less than the threshold, there is no additional power supply for the lock device 200, and the key device 100 supplies the lock device 200 with electricity.

In some embodiments, the communication and power transmitting module 110 and the communication and power receiving module 210 are wireless communication modules and support near field communication (NFC) or other short distant wireless communication protocols.

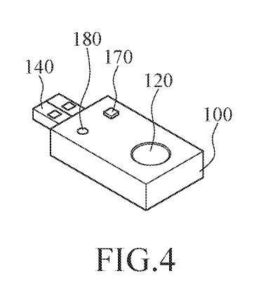

As shown in FIG. 3, the key device 100 further comprises a charging circuit 150 and a charging port 160. The charging port 160 receives an external power. The charging circuit 150 charges the battery 130 by the electricity of the external power. In the embodiment, the battery 130 is a rechargeable battery. The charging port 160 supports the universal serial bus (USB) or other transmission protocols. In an embodiment, the charging port 160 can be integrated with the connecting plug 140, as shown in FIG. 4.

As shown in FIG. 3, the key device 100 further comprises a mating button 170 and an indicating module 180. Initially, in order to establish a fingerprint file (i.e., the verification data) of the user in the lock device 200, the user can press the fingerprint sensing module 120 with his or her finger and then hit the mating button 170 when the key device 100 and the lock device 200 are connected to each other via wire or in a wireless manner, such that the fingerprint sensing module 120 can start to sense (collect) the fingerprint data. Additionally the communication and power transmitting module 110 transmits a mating signal to the lock device 200 in response to the mating button being triggered. The mating signal comprises the fingerprint data sensed by the fingerprint sensing module 120. The lock device 200 stores the fingerprint date of the mating signal as the verification data. The lock device 200 responds to the key device 100 with a mating accomplished message when the verification data is stored. The indicating module 180 of the key device 100 outputs an indicating signal in response to the mating accomplished message. In the embodiment, the indicating module 180 can be an indicating light, a speaker, or other outputting devices capable of notifying the user by light, sound, or other forms that the fingerprint file is established. After that, the user can unlock the lock device 200 with his or her fingerprint.

Concisely, according to the embodiments of the instant disclosure, the fingerprint lock system has less risk of the lock device 200 being sabotaged since the lock device 200 and the key device 100 are separated. Additionally a user can use the same key device 100 to unlock multiple lock devices 200 and consequently has no need to carry multiple keys, which is more convenient. Additionally, the lock device 200 can operate based upon the supplying power provided by the key device 100 and has no need to depend on additional power supply. As a result, the lock device 200 consumes less power and avoids an issue that the lock device 200 may be unable to be unlocked in the case of the lock device 200 running out of power or the additional power supply being interrupted.

While the instant disclosure has been described by way of example and in terms of the preferred embodiments, it is to be understood that the instant disclosure needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A fingerprint lock system, comprising:
a key device comprising a communication and power transmitting module, a fingerprint sensing module, and a battery, the battery providing an operating power to supply operation of the communication and power transmitting module and the fingerprint sensing module, the fingerprint sensing module sensing a fingerprint input and accordingly generating fingerprint data, the communication and power transmitting module outputting the fingerprint data and a supplying power; and
a lock device comprising a communication and power receiving module, a storage module, and a processing module, the communication and power receiving module receiving the fingerprint data and the supplying power from the key device to supply the storage module and the processing module with the supplying power, the storage module storing at least one verification data, each of the verification data comprising a plurality of minutiae features corresponding to a fingerprint, the processing module verifying if the fingerprint data has the minutiae features corresponding to the fingerprint and, if so, performing an unlock operation.

2. The fingerprint lock system of claim 1, wherein the lock device further comprises a housing, the communication and power receiving module comprises a connecting receptacle, the connecting receptacle is exposed from a surface of the housing, the storage module and the processing module are received in the housing, the communication and power transmitting module of the key device comprises a connecting plug for being connected to the connecting receptacle and to transmit the fingerprint data and the supplying power.

3. The fingerprint lock system of claim 2, wherein the communication and power transmitting module further comprises a voltage sensing unit for sensing a voltage signal of the lock device via the connecting plug when the connecting plug and the connecting receptacle are connected to each other and outputting the supplying power to the lock device when the voltage signal is less than a threshold.

4. The fingerprint lock system of claim 1, wherein the communication and power transmitting module and the communication and power receiving module are wireless communication modules.

5. The fingerprint lock system of claim 1, wherein the key device further comprises a charging circuit and a charging port, the charging port receives an external power, and the charging circuit charges the battery by electricity of the external power.

6. The fingerprint lock system of claim 1, wherein the key device further comprises a mating button, the communication and power transmitting module transmits a mating signal to the lock device in response to the mating button being triggered, the mating signal comprises the fingerprint data sensed by the fingerprint sensing module, and the lock device stores the fingerprint date of the mating signal as a verification data.

7. The fingerprint lock system of claim 6, wherein the key device further comprises an indicating module, the lock device responds to the key device with a mating accomplished message when the verification data is stored, and the indicating module of the key device outputs an indicating signal in response to the mating accomplished message.

8. A key device, comprising a communication and power transmitting module, a fingerprint sensing module, and a battery, the battery providing an operating power to supply operation of the communication and power transmitting module and the fingerprint sensing module, the fingerprint sensing module sensing a fingerprint input and accordingly generating fingerprint data, the communication and power transmitting module outputting the fingerprint data and a supplying power generated based upon the operating power.

9. The key device of claim 8, wherein the communication and power transmitting module further comprises a connecting plug and a voltage sensing unit, the connecting plug is for being connected to a connecting receptacle of a lock device, and the voltage sensing unit is for sensing a voltage signal of the lock device via the connecting plug when the connecting plug and the connecting receptacle are connected to each other and outputting the supplying power to the lock device when the voltage signal is less than a threshold.

10. The key device of claim 9, further comprising a charging circuit, a charging port, a mating button, and an indicating module, the charging port receives an external power, the charging circuit charges the battery by electricity of the external power, the communication and power transmitting module transmits a mating signal to the lock device in response to the mating button being triggered, the mating signal comprises the fingerprint data sensed by the fingerprint sensing module, the lock device stores the fingerprint data of the mating signal as a verification data, the lock device responds to the key device with a mating accomplished message when the verification data is stored, and the indicating module of the key device outputs an indicating signal in response to the mating accomplished message.
